(19) United States
(12) Patent Application Publication
(10) Pub. No.: US 2018/0186612 A1
(43) Pub. Date: Jul. 5, 2018

(54) Lifting Device for Lifting a Vehicle with Integrated Motor Control, and System and Method Therefor

(71) Applicant: Stertil B.V., Kootstertille (NL)

(72) Inventor: Jurjen Jan De Jong, Buitenpost (NL)

(21) Appl. No.: 15/856,358

(22) Filed: Dec. 28, 2017

(30) Foreign Application Priority Data
Jan. 4, 2017 (NL) 2018121

(51) Int. Cl. B66F 5/04

(52) U.S. Cl. CPC B66F 5/04

(57) ABSTRACT

The present invention relates to a lifting device system for lifting a vehicle, and lifting system and method therefor. The lifting device according to the invention includes a frame with a moveable carrier configured for carrying the vehicle; a drive system which acts on the carrier and is configured for raising and/or lowering the carrier relative to the frame; and a controller and a control measurement system. The controller is configured for controlling the height of the carrier in response to a measurement signal from the control measurement system. The drive system comprises a motor with an integrated motor controller.

### CROSS-REFERENCE TO RELATED APPLICATION

This application claims priority to Dutch Patent Application No. 2018121 filed Jan. 4, 2017, the disclosure of which is hereby incorporated in its entirety by reference.

### FIELD

The invention relates to a lifting device for lifting a vehicle such as passenger cars, trucks, busses and other vehicles, and more specifically a mobile lifting column such as a wireless mobile lifting column.

### BACKGROUND

Lifting devices including lifting columns are known from practice and comprise a frame with a carrier that is connected to a drive for moving the carrier upwards and downwards. In the ascent mode, hydraulic oil is pumped to a cylinder for lifting the carrier and, therefore, the vehicle. In the descent mode, the carrier with the vehicle is lowered and hydraulic oil returns to the reservoir. Such prior art lifting system is disclosed in U.S. Patent Application Publication No. 2006/0182563, which is incorporated herein by reference. Conventional lifting systems require relatively sophisticated controllers for control of its drive system. This involves a number of components thereby contributing to the overall complexity of the system. Also, it renders such lifting systems cost ineffective.

An object of the present invention is to obviate or at least reduce the aforementioned problems associated with conventional lifting devices.

### SUMMARY

This object is achieved with the lifting device for lifting a vehicle, such as a passenger car, truck, bus or other vehicle, with the lifting device comprising:
a frame with a moveable carrier configured for carrying the vehicle;
a drive system which acts on the carrier and configured for raising and/or lowering the carrier relative to the frame; and
a controller and a control measurement system, wherein the controller is configured for controlling the height of the carrier in response to a measurement signal from the control measurement system, wherein the drive system comprises a motor with an integrated motor controller.

The carrier of the lifting device is capable of carrying the vehicle that needs to be lifted.

The carrier moves upward and/or downward relative to the frame of the lifting column with a drive system. The carrier comprises a carrying part that is configured for carrying a vehicle, or at least a part thereof. The carrier further comprises a guiding part that enables a guiding movement relative to the frame of the lifting device. In a presently preferred embodiment, the drive system comprises a hydraulic cylinder drive unit that is configured for raising the carrier. This unit comprises a housing, a piston rod that is movable in the housing of the cylinder, and a hydraulic system. Alternatively, another drive system can be used, for example a pneumatic and/or electrical drive system. In one of the presently preferred embodiments of the invention the unit is embodied as an integrated hydraulic cylinder drive unit as disclosed in U.S. Patent Application Publication No. 2016/0052757.

The lifting device comprises a controller that is configured for controlling the height of the carrier. The controller can be provided at or in the frame of the lifting device, or may relate to a central controller capable of controlling a number of lifting devices and/or several groups of lifting devices, or any mixture thereof. Preferably, the controller also comprises a display and optionally other user interfaces to enable communication with the user. Also, the controller may comprise a display to improve this communication.

According to the invention, the controller comprises a control measurement system wherein the controller is configured for controlling the height of the carrier in response to a measurement signal from the control measurement system. This control measurement system is configured for indirectly and/or directly measurement of the height and/or displacement of the carrier. This control measurement system provides information about the control actions of the drive system for the carrier and/or the height of the carrier. This provides direct and/or indirect measurement information enabling feedback on the actual position and/or displacement of the carrier. The controller is preferably capable of receiving a measurement from a control measurement system comprising one or more sensors or sensor systems that are capable of indicating one or more of: a height of the carrier, height difference of the carrier, moving speed of the carrier, information about the control actions directed towards the drive, such as the amount of hydraulic oil sent to the drive for raising or lowering the carrier relative to the frame.

This control measurement system may comprise a sensor or sensor system on the carrier or frame such as a potentiometer and/or sensors for measuring control actions and/or indirect measurement systems that may measure changes in the hydraulic system such that any measurement of a displacement of the carrier is directly available preventing time delays and, if necessary, such that appropriate control actions can be taken directly. This may improve the safety of the lifting device according to the present invention. According to the invention the drive system of the lifting device comprises a motor with an integrated motor controller. This has the advantage that no additional wiring is required between the motor of the drive system and the motor controller. Preferably, the motor and the motor controller are separate parts or components that can be manufactured independently and also maintenance can be done independently. In a presently preferred embodiment the drive system of the lifting device comprises a hydraulic system. Preferably, the motor comprises a pump connection configured for directly connecting the motor to the pump of the hydraulic system of the lifting device.

In a presently preferred embodiment components of the drive system, such as the motor and the motor controller, are connected with watertight connectors. This improves the overall safety of working with the lifting system of the invention. Furthermore, the connectors connecting a first component to a second component of the drive system are mounted from below. This further improves the overall safety of working with the lifting device of the invention. This specifically reduces the risk of damage due to water penetrating the lifting device. In a presently preferred embodiment the motor comprises a permanent-magnet (PM) motor.

The permanent-magnet motor, also referred to as PM-motor, enables an effective drive for the carrier enabling raising and/or lowering the carrier relative to the frame with or without a load. As a further advantage the PM motor operates as a generator when lowering the carrier, specifically with a load resting thereon, relative to the frame. Using the motor as a generator in lowering the carrier generates electrical energy that can be used for the next lifting operation, for example. This can be advantageously applied to mobile lifting devices, such as mobile lifting columns that rely on a battery for the lifting operation. The use of a PM motor enables a higher number of lifting operations without recharging the battery and/or enables the use of a smaller battery. Therefore, the PM motor contributes to a more sustainable lifting device and/or enables more lifting operations without recharging a battery.

In a presently preferred embodiment the drive system comprises a hydraulic system having a hydraulic reservoir, wherein the reservoir extends over a substantial height of the frame.

Providing a hydraulic system for the drive system gives a reliable and robust lifting device. Providing an extended reservoir with having a height that extends over a substantial height of the frame enables a compact design of the lifting device. This contributes to easy installation of the lifting device and/or easy displacement and positioning of a mobile lifting device. Preferably, the height of the reservoir is significantly higher as compared to the width and/or depth of the reservoir. In use, the height of the reservoir extends in a substantial vertical direction, while the depth and width of the reservoir are in a substantially horizontal plane. Preferably, the height of the extended reservoir is more than twice the size of the width and/or depth of the reservoir, more preferably the ratio of the height of the reservoir and the size of the width or depth is above 3, even more preferably above 5, and most preferably above 7.

In a presently preferred embodiment the pump of the hydraulic system is positioned below the reservoir. This assures that hydraulic oil is at all circumstances provided from the reservoir to the pump without requiring additional piping or tubing.

In one of the presently preferred embodiments of the invention, the control measurement system comprises a sensor configured for generating the measurement signal for determining a control action with the controller related to the drive system of the lifting device, with the sensor configured for generating an indirect measurement signal from the hydraulic system. Using direct (control) information about the control actions of the drive system enables taking fast control actions without unnecessary time delays. This improves the overall control performance of the lifting device of the invention. The direct (control) information relates to information about the hydraulic system, for example the amount of hydraulic oil sent to the drive for raising or lowering the carrier relative to the frame.

As a further advantage, the indirect measurement in the hydraulic system provides an explosion proof measurement system. This further improves the overall safety of lifting systems for lifting a vehicle.

In addition, Providing an indirect measurement based on the hydraulic system, preferably measuring changes in the hydraulic system, enables a detection of any leakage of hydraulic fluid from the system. This improves the environmental performance of the lifting system. Furthermore, the measurement can be compared with the theoretical changes of the hydraulic system by comparing with the motor RPM thereby further enabling and/or improving a detection of any leakage. Furthermore, such comparison may provide an indication of wear of components of the system. This may provide an accurate indication of required preventive maintenance.

In an embodiment of the present invention, the measurement system comprises a sensor that is contained inside the hydraulic system, for example in the hydraulic reservoir and/or in the hydraulic connections, such as pipes or tubes. This provides a stable environment for the sensor or sensor components. This reduces the risk of fouling or temperature fluctuations that may influence the measurements. Therefore, this contributes to the accuracy and robustness of the measurement system in such embodiment.

In such preferred embodiment the lifting system comprises a control measuring system that is configured for indirectly measuring the height and/or displacement of the carrier through the use of a measurement of the hydraulic system. The use of this measuring system provides information about the height of the carrier. This measuring system provides an indirect measurement enabling feedback on the actual displacement of the carrier. This obviates the need for separate sensor systems on the carrier or frame, such as a potentiometer, thereby reducing the complexity of the lifting device, and reducing the risk of additional noise or disturbances influencing measurement signals and/or communication between the different components of the lifting device. This improves the accuracy and/or robustness of the measurement system.

Furthermore, as the measurement of the control measurement system is based on (a change) in the hydraulic system any measurement of a displacement is directly available such that there is no time delay and, if necessary, appropriate control actions can be taken directly. This improves the safety of the lifting device according to the present invention. In one of the preferred embodiment of the invention the sensor of the control measurement system is configured for measuring the level, pressure, or volume of the hydraulic liquid and/or the change thereof. More specifically, in such embodiment of the invention, the measurement system preferably comprises a sensor that is contained inside the hydraulic system, for example in the hydraulic reservoir and/or in the hydraulic connections, such as pipes or tubes.

By measuring the level or volume of the hydraulic liquid in the reservoir, or a change thereof, the measurement signal is indicative for the amount of hydraulic liquid that is provided towards the drive, such as a cylinder, that moves the carrier is achieved. This provides indirect measurement information about the height of the carrier or change thereof, even before actual displacement of the carrier takes place. In fact, this provides measurement information about the control actions of the drive system. This achieves the aforementioned effects and advantages. It will be understood that the level indication of the hydraulic liquid in the reservoir relates to the amount of hydraulic liquid that is provided to and/or received from the drive. It will be understood that any shape of the reservoir can be compensated for.

The sensor preferably comprises one or more of the following sensors: an ultrasonic hydraulic liquid level sensor, a float sensor configured for measuring the hydraulic liquid level, a pressure sensor configured for measuring pressure and/or pressure differences in the reservoir.

These sensors have the further advantage that long cables that are connected to a moving carrier can be omitted from the lifting device as compared to a sensor that is mounted to the moveable carrier, such as a potentiometer. This provides an effective system without unnecessary complexity. An ultrasonic sensor can be provided above the hydraulic liquid level and measure a distance from the reference point of the sensor to this surface level. Any change of this distance indicates a change of the height of the carrier of the lifting system. Preferably, the sensor is mounted at the top of the reservoir, preferably a reservoir with an extended and/or substantial height. The ultrasonic sensor, also referred to as ultrasound sensor, sends a signal that is reflected from the oil level in the reservoir. The preferred extended height of the reservoir contributes to an effective measurement and more specifically contributes to providing a more accurate measurement signal. In a presently preferred embodiment the reservoir is designed such that there is a ratio between a height change of the carrier and the oil level that is between 1:1 and 1:10, preferably between 1:2 and 1:5, and is most preferably about 1:3. A ratio of 1:3 means that a height change of the carrier of 3 mm corresponds to a change in oil level in the reservoir of 1 mm. This provides an accurate measurement. In this embodiment, preferably the pump is mounted below the reservoir. This obviates the need for additional piping or tubing. This has the additional advantage that the risk of disturbances acting on the measurement is further reduced.

In a similar way, a float sensor can be implemented as an alternative or in addition to the ultrasonic sensor. Such float sensor may comprise an electromagnetic float and/or resistance element and/or an inclinometer. This provides a direct measurement of any change of the level of the hydraulic liquid surface.

A pressure sensor can be applied to measure and pressure differences in response to a change in the volume of the hydraulic liquid in the reservoir. This may involve providing a pressure sensor in the room or chamber above the hydraulic liquid surface and/or providing a pressure sensor in a separate measurement tube that is connected to the hydraulic reservoir and/or a weight measurement of the hydraulic liquid that is contained in the reservoir.

In addition to the aforementioned sensor types, or as an alternative thereto, a flow sensor can be provided in the hydraulic liquid pipe or tube between the reservoir and the drive. The drive may relate to components such as the hydraulic pump of the drive and/or hydraulic cylinder of the drive. Such flow sensor provides an accurate measurement of the amount of hydraulic liquid that is transferred between the reservoir and the drive unit.

In some of the embodiments of the invention one or more additional sensors can be provided to improve the accuracy of the measurement. For example, a temperature sensor can be provided at or close to the location of the sensor of the measurement system to enable temperature correction of the measurement signal. This further improves the overall accuracy of the measurement information.

In a further preferred embodiment according to the invention the drive comprises a reservoir with a submerged pump. By providing a submerged pump a compact and effective hydraulic circuit is achieved with a significant reduction of the number of hoses and connections. This further reduces the risk of hydraulic fluid, such as hydraulic oil, leaking from the lifting system. In addition, the amount of hydraulic liquid that is required for a lifting system is further reduced.

Furthermore, the lifting device according to the present invention preferably comprises an integrated hydraulic fluid tank and motor unit. Integrating the hydraulic fluid tank and motor in one unit reduces the need for space required for these components in the lifting device and enables a relatively compact construction. Such compact construction significantly reduces the number and/or length of hoses and other connections between the individual units or components of the lifting device according to the present invention. This renders the lifting device according to the invention more cost effective and, in addition, reduces the risk of failure of components and/or connections. In particular, the risk of hydraulic fluid leaking from a connection is reduced significantly.

In a further presently preferred embodiment of the invention the drive system comprises an integrated hydraulic cylinder drive unit that is configured for raising the carrier. This unit comprises, in an integrated manner, a housing, a piston rod that is movable in the housing of the cylinder, and a piston rod displacement measuring system that is configured for measuring the displacement of the piston rod.

The use of this piston rod displacement measuring system enables the direct measurement of a displacement of the the piston rod that is directly related to the height of the carrier. This provides a direct (control) measurement enabling direct feedback on the actual displacement of the carrier. This obviates the need for separate sensor systems, thereby reducing the complexity of the lifting device, and reducing the risk of additional noise or disturbances on measurement signals and/or communication between the different components of the lifting device. Furthermore, as the height measurement can be performed directly on the displacement of the piston rod the feedback of the displacement is directly available to the controller such that there is no time delay and, if necessary, appropriate control actions can be taken directly. This improves the safety of the lifting device according to the present invention.

Providing a sensor code directly on the piston rod enables a direct measurement of the displacement of this piston rod by providing a sensing element. This sensing element is configured for reading the sensor code to determine the displacement. This enables a direct measurement of the displacement of the piston rod and, therefore, the location of the carrier of the lifting device.

In a presently preferred embodiment the sensor code is a magnetic code. The piston rod acts as host for the sensor code and is preferably of a steel material. The sensing element is preferably a row of magnetic field sensors which are located in the proximity of the sensor code. The use of such configuration enables measuring changes in the magnetic field(s) caused by displacement of the piston rod such that the sensing element, for example embodied as coils, respond to the magnetic field changes. This provides a measurement of the actual displacement of the piston rod and therefore of the height of the carrier of the lifting device. The measurement signal can be supplied to a lifting device controller that monitors and controls the height of the carrier. If required, the lifting device controller may compare the height of an individual carrier with heights of other carriers and determine corrective action, if necessary. Such corrective action may involve raising or lowering individual carriers in addition to the original steering command.

Optionally, embodiments of the lifting system of the invention comprise a locking system for locking the carrier at a desired height and/or submersible pump as is disclosed in U.S. Pat. No. 14/791,644, for example, which is incorporated herein by reference.

In a presently preferred embodiment of the invention the drive system of the lifting device further comprises an energy supply with a battery.

By providing a battery the lifting device may relate to a so-called stand-alone lifting device, such as a mobile lifting column. These mobile lifting columns can be wired or wireless. In one of the preferred embodiments the energy supply comprises at least two batteries. This provides additional flexibility as, preferably, the batteries can be charged and/or replaced independently from each other. Also, the use of two or more batteries enables providing a worldwide applicable lifting device capable of dealing with different voltages including 120/240 VHC 50/60 Hz by adapting the actual circuit of the batteries to the relevant national standard.

Also preferably, the lifting device comprises a charging device. More preferably, the charging device comprises separate charging circuits for the different batteries, preferably at least two 12 V batteries that can be charged independently. This enables optimal charging of the batteries and enables independent replacement. The charging device is preferably included in the frame of the lifting device thereby providing a watertight configuration, for example an IP68 watertight configuration. Preferably, the one or more batteries are provided in or at the frame at a position below the drive system. This specific configuration enables a compact design of the lifting device. Furthermore, the center of gravity is at a lower position as compared to conventional lifting devices. This improves the overall stability of the lifting device according to the invention.

Also preferably, the controller comprises a charging monitor that is configured for monitoring the regenerative charging process when lowering a load. This charging of the batteries when lowering a load increases the number of lifting cycles that can be performed between charging operations of the battery. Preferably the charging monitor provides the user with information on a display or other suitable means.

The controller further preferably comprises a resistance and a switch circuit that are operatively connected to the charging monitor and capable of preventing overcharging of the one or more batteries. This provides a safety measure preventing overcharging the batteries. In case the batteries are full and the load is lowered the generated energy is provided to the resistance with a switch circuit to prevent this overloading. This improves the reliability and robustness of the lifting system of the invention.

As an alternative to the switch circuit with the separate resistance the lowering of the carrier can be done with a reduced velocity to prevent regenerating of energy, in case the charging monitor detects that batteries are completely full.

By integrating the charging device and charging monitor in the frame of the lifting device a compact design is achieved that is robust and less sensitive to disturbances and fouling as compared to conventional lifting devices. This improves the overall functioning of the lifting device of the invention.

In a further preferred embodiment of the invention the frame comprises a foot having a tapering part with an additional running wheel at or near the front of the foot of the frame.

By providing the foot with a tapering part the overall stability of the lifting device is improved. The tapering part has the highest thickness or height close to the mast of the frame. This improves the overall strength and stability without increasing the amount of material that is required for stable positioning of the lifting device. This is particularly advantageous for mobile lifting columns.

Preferably, the frame of the lifting device comprises a modular cartridge containing an additional running wheel at or near the front of a foot of the frame. This provides an effective means for positioning or displacing lifting systems, in particular mobile lifting columns.

In a further preferred embodiment of the invention the controller of the lifting device comprises a connectivity module configured for communicating with an external system.

By providing the controller with an activity module the lifting device may communicate with external systems such as a counting, maintenance, logistics, planning. Also, this module may be used when communicating with a central controller in case the lifting device is part of a wider lifting system.

Lifting devices according to the invention include lifting columns of the two-post lift type with pivoting support arms, the four-post lift type with runways, the mobile type lifting columns, in-ground lifts etc.

In one of the presently preferred embodiments of the invention the lifting device relates to a lifting column and more preferably to a (wireless) mobile lifting column.

The present invention also relates to a lifting system comprising one or more of the aforementioned lifting devices, more preferably comprises one or more lifting columns, and most preferably one or more mobile lifting columns.

The lifting system provides the same effects and advantages as those stated for the lifting device. For example, the lifting system may comprise a number of (mobile) lifting columns acting as lifting device. The individual lifting devices/columns can be controlled by a central controller of the lifting system, for example.

Preferably, a number of lifting devices, more specifically a number of (mobile) lifting columns can be grouped together as a lifting system. In an embodiment of such a lifting system according to the invention, when lifting a vehicle, at least two lifting columns are being used. In fact, in practice often four lifting columns are being used. During such lifting operation, the timing of these separate lifting columns including the moving speed of the carrier that carries (part of) the vehicle when lifting a vehicle, requires synchronization. The control of the lifting system preferably comprises a system controller that synchronizes the height of the separate carriers in the ascent mode using, for example, a measurement signal generated by a height sensor, for example a potentiometer, and/or more preferably a measurement signal generated by the control measurement system according to a presently preferred embodiment of the present invention. Of course, other sensors can also be used.

In case one of the carriers has moved too fast in the ascent mode and is too high as compared to the other carriers of the other lifting columns, for example the power supply to this carrier is either directly or indirectly lowered so that the other carriers can catch up or, alternatively, the power supply to the other carriers is either directly or indirectly increased so that the other carriers can catch up. In the descent mode, it is also important that the height of the carriers between the several lifting columns is synchronized. Therefore, in case one of these carriers has moved too slowly, for example its power supply is increased in order for this carrier to catch up with the other carriers or, alternatively, the power supply to the other carriers is either directly or indirectly lowered so that the other carriers can catch up.

The present invention also relates to a method for lifting a vehicle, the method comprising the steps of:
providing a lifting device or lifting system according to one or more of the embodiments of the present invention; and
lifting the vehicle with the drive acting on the carrier.

The method provides the same effects and advantages as those stated for the lifting device and/or lifting system. The lifting system may comprise a number of mobile lifting columns acting as lifting system, for example. The individual lifting devices or lifting columns can be controlled by a central controller of the lifting system, for example. This further improves the accuracy and safety of the lifting system.

In an embodiment of the invention the method comprises indirectly measuring the hydraulic liquid level, pressure, or volume and/or a change thereof. This provides an effective control of the lifting operation. In addition thereto or as an alternative thereto, the flow between the drive of the carrier and the hydraulic liquid reservoir can be measured.

### BRIEF DESCRIPTION OF THE DRAWINGS

Exemplary embodiments of a lifting system and/or the method according to the present invention are described here below on the basis of a non-limitative exemplary embodiment therefor shown in the accompanying drawings, wherein:

FIG. 1 shows a lifting system comprising a number of mobile lifting columns according to the present invention;

FIG. 2 shows a mobile lifting column of the type shown in FIG. 1;

FIG. 3 shows a further view of the mobile lifting column of FIG. 2;

FIG. 4 shows the configuration of the drive system of the lifting column of FIGS. 1-3;

FIG. 5 shows details of the drive with motor and integrated motor controller;

FIG. 6 shows details of the hydraulic reservoir; and

FIG. 7 shows the foot of the lifting column with modular cartridge.

### DETAILED DESCRIPTION

The following description is merely exemplary in nature and is in no way intended to limit the invention, its application, or uses. While the disclosure is described as having exemplary attributes and applications, the present disclosure can be further modified. This application is therefore intended to cover any variations, uses, or adaptations of the disclosure using its general principles. Further, this application is intended to cover such departures from the present disclosure as come within known or customary practice of those skilled in the art to which this disclosure pertains and which fall within the limits of the appended claims. Accordingly, the following description of certain embodiments and examples should be considered merely exemplary and not in any way limiting.

The lift control system of the present invention is suitable for use with lift systems comprising any number of lifting devices that require height control columns, including systems having one, two, four or another number of columns. The columns may achieve lifting and lowering capability by any means known to those of skill in the art, including hydraulically, electrically, mechanically, and electromechanically. Lift systems compatible with the present lift control system may involve wired and/or wireless communication. With reference to the figures, like element numbers refer to the same element between drawings.

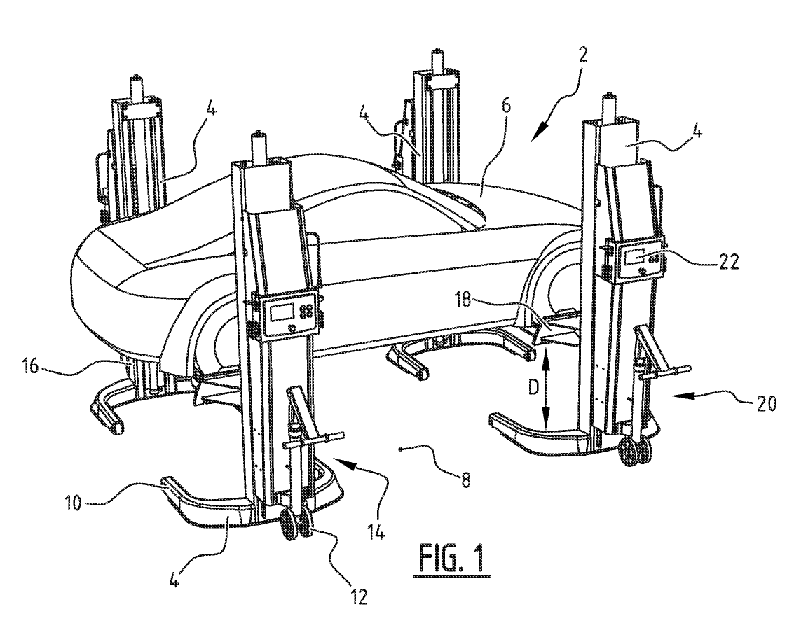

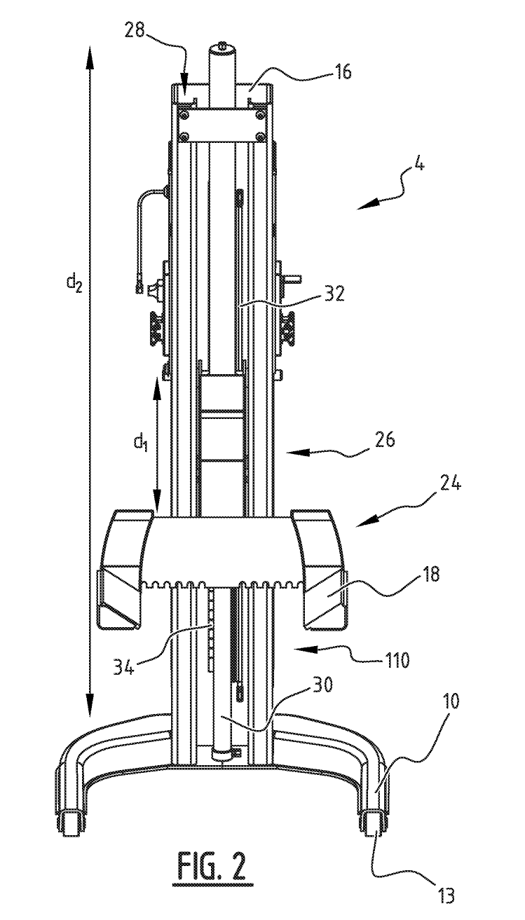

System 2 for efficient lifting and lowering load 6 (FIG. 1) comprises four wireless mobile lifting columns 4. Lifting columns 4 lift passenger car 6 from ground 8. In the illustrated embodiment lifting columns 4 are connected to each other and/or a control system by wireless communication means or alternatively by cables. Lifting columns 4 comprise foot 10 which can travel on running wheels 12 over ground surface 8 of for instance a floor of a garage or workshop. In the forks of foot 10 is provided an additional running wheel 13 (FIG. 2). Running wheel 12 is part of pallet truck mechanism 14 enabling easy manoeuvring of lifting column 4. Lifting column 4 furthermore comprises mast 16. Carrier 18 is moveable upward and downward along mast 16. Optionally, adapters can be used to adjust carrier 18 to specific wheel dimensions. Carrier 18 is driven by motor/drive system 20 that is preferably provided in a housing of lifting column 4. System 20 is supplied with power from the electrical grid or by a battery that is provided on lifting column 4 in the same housing as system 20, or alternatively on foot 10 (not shown), for example. Lifting column 4 is provided with control panel 22 to allow the user of system 2 to control the system, for example by setting the speed for carrier 18. In one embodiment, the motor of system 20 is a 3-phase low voltage motor controlled by a separate controller. In another embodiment, the motor of system 20 is a 3-phase low voltage motor with integrated controller. Such motor with integrated controller can also be used in combination with conventional lifting devices with conventional height measurement systems. Each of the lifting columns has at least one ascent mode and one descent mode, and is under the influence of integrated controller with control panel 22. Controller 22 can be designed for each lifting column 4 individually, or for the lifting columns 4 together. A pressure or load sensor may be used for monitoring, control and indication of the correct positioning of the load that is lifted with lifting system 2. Carrier 18 (FIG. 2) comprises carrying part 24 and guiding part 26. Guiding part 26 extends over length d₁ along guide rail 28 in a substantial vertical direction. Guide rail 28 is provided with cylinder 30. Guide rail 28 extends over length d₂ along mast 16. It is noted that this length d₂ is mostly related to the length or height of cylinder 30. Mast 16 also houses locking system 32 and locking rail 34. In the illustrated embodiment locking rail 34 extends over a substantial part of the length or height of mast 16.

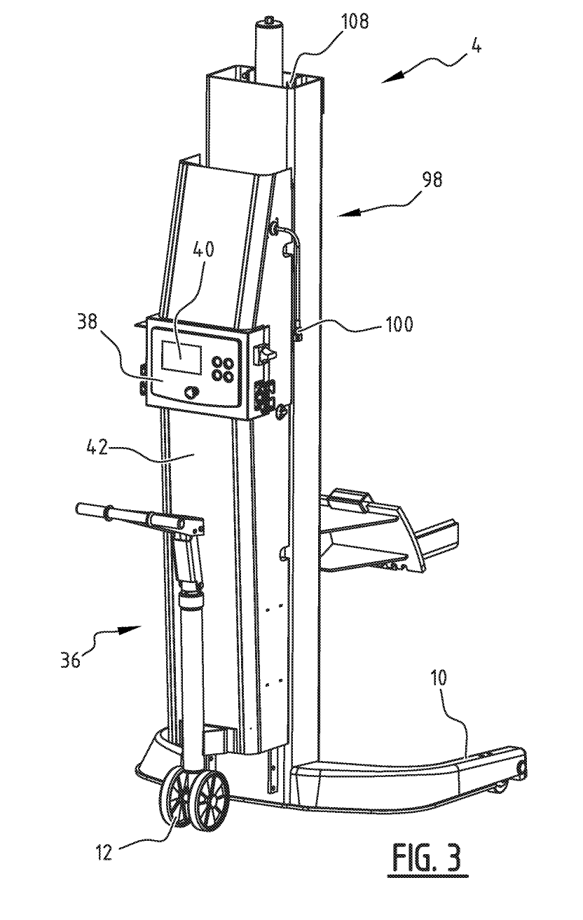

Lifting column 4 comprises pallet truck mechanism 36 (FIG. 3) for displacing/positioning lifting column 4. An operator is provided with information and/or provides input to lifting column 4 with control unit 38 that comprises display 40. Lifting column 4 further comprises cover 42. Cover 42 protects a number of components against fouling and damage. Charger 98 and connector 100 (FIG. 3) are provided behind cover 42. This provides an integrated design.

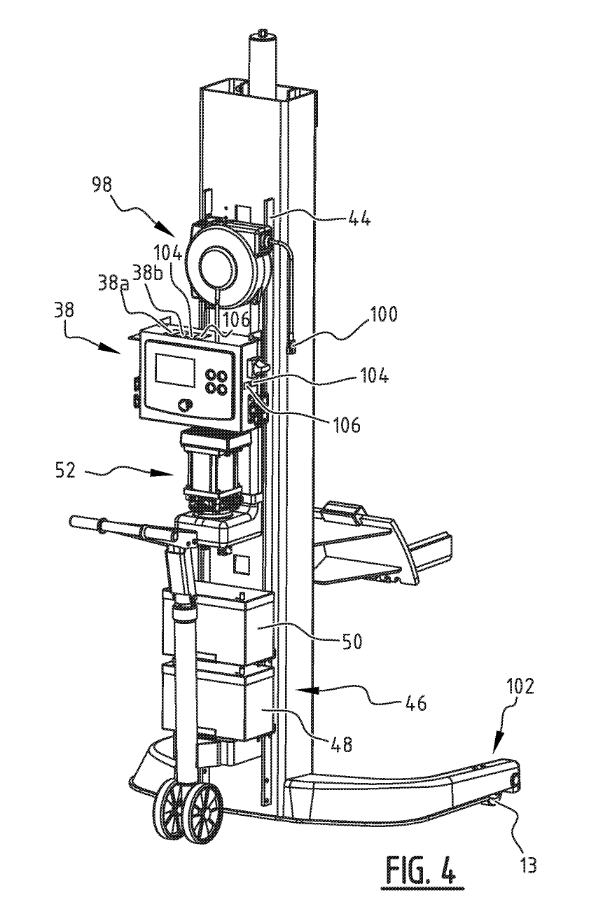

Mounting rail 44 (FIG. 4) enables a robust connection of cover 42 to frame of lifting column 4. An energy system 46 comprises first battery 48 and second battery 50. Drive system 52 is in the illustrated embodiment provided above energy system 46. An overcharge monitor 104 is provided in control unit 38 that also comprises an integrated switch circuit 38a and resistance 38b for a safety measure to prevent overcharging of batteries 48, 50. Connectivity module 106 is also provided in control unit 38 to connect lifting column 4 with other systems. Optionally sensor 108 is provided at mast 16 of lifting column 4 to detect the velocity of a moving carrier 18.

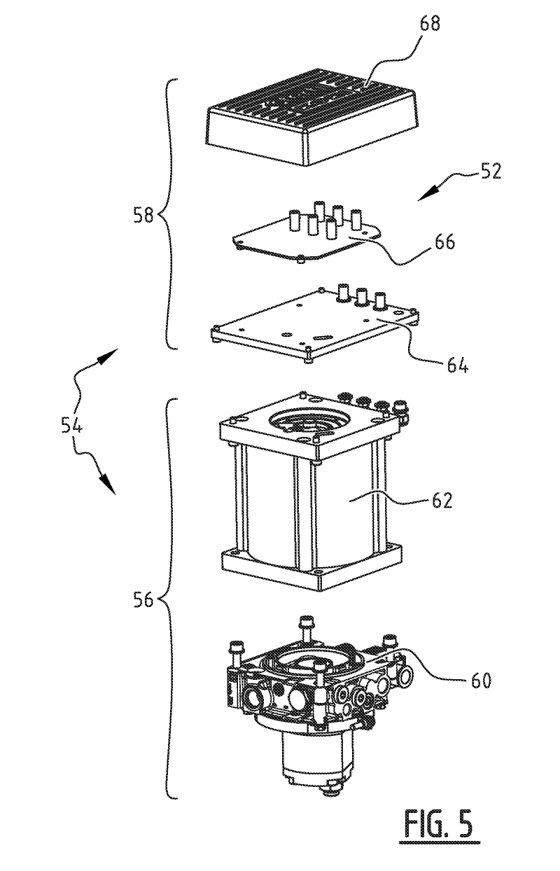

Drive system 52 comprises integrated system 54 (FIG. 5) comprising motor and pump assembly 56 and motor controller 58. Assembly 56 comprises pump and valve 60 and PM motor 62. Motor controller 58 comprises plate 64, print 66 and cover 68.

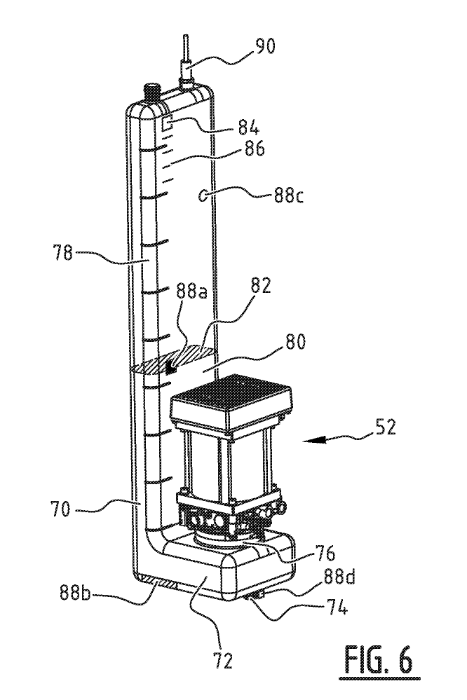

Drive system 52 further involves reservoir 70 (FIG. 6). In the illustrated embodiment reservoir 70 has bottom part 72 with opening 74 and pump connection 76. Reservoir 70 is further provided with vertical extending part 78.

In use, reservoir 70 is filled with hydraulic oil 80 defining oil level 82. In the illustrated embodiment several sensors have been illustrated. It will be understood that these relate to exemplary embodiments of the invention and other configurations of one or more of these sensors or further alternative sensors can also be envisaged in accordance with the invention. In the illustrated embodiment ultrasonic sensor 84 is mounted at the top of the vertical part 78 of reservoir 70. Sensor 84 provides signal 86 that is reflected by oil level 82. This indicates the position of oil level 82. Float 88a also measures oil level 82. Load cell 88b measures the amount of oil in reservoir 70. Pressure sensor 88c measures pressure differences indicating the position of oil level 82. Flow sensor 88d measures the amount of flow from and/or to reservoir 70. Furthermore, in addition or as an alternative to the aforementioned sensor(s), a flow sensor can be provided in hydraulic circuit, for example in suction pipe. It will be understood that other locations for flow sensor can also be envisaged in accordance with the present invention.

Reservoir 70 is provided with connection 90 to connect sensors 84, 86, 88a-d to control unit 38.

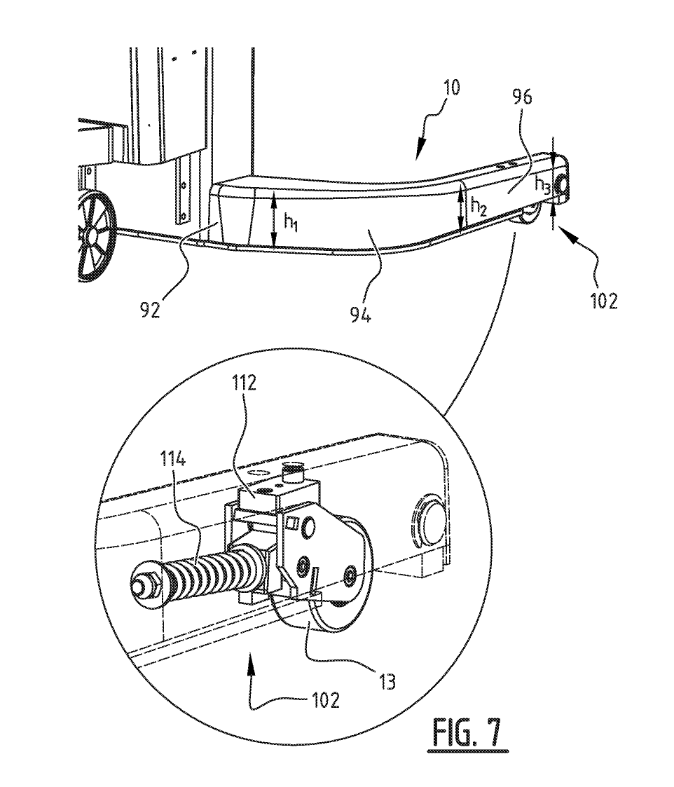

Foot 10 of lifting column 4 (FIG. 7) comprises connecting part 92 having height hi, curve part 94 with height h₂ and front part 96 having height h₃, with decreasing height from h₁ to h₃. This provides maximum strength at connecting part 92 and maximum space for manoeuvring at part 96.

Front running wheel or additional wheel 13 is provided in cartridge 102 that is located in front part 96 of foot 10. Cartridge 102 (detail of FIG. 7) comprises frame 112 and spring element 114. Cartridge 102 is designed that it may be replaced as a whole, including additional wheel 13. In an alternative embodiment lifting column 4 is provided with a further measurement system 110 that measures displacement of a piston that drives carrier 18. Such measurement system is disclosed in U.S. Patent Application Publication No. 2016/0052757, which is incorporated herein by reference. This measurement system a hydraulic circuit is operatively connected to hydraulic cylinder with the piston. Controller 38 receives measurement signals from sensors 84, 86, 88a-d and/or other sensors. Controller 38 determines the height of carrier 18. Preferably, controller 38 is connected to a central controller configured for controlling the lifting columns, optionally communicating with (local) controllers of lifting devices. The central controller and/or controller 38 determine the height and/or speed differences between individual carriers 18 of a lifting system (FIG. 1) and determine required control actions. These control actions may result in sending control signals/actions to motor/pump assembly 54 of drive system 52.

When lifting car 6 a number of mobile lifting columns 4 are positioned around vehicle 6. When the lifting operation is approved carriers 18 start moving along masts 16. As soon as the desired height D above ground surface 8 of carriers 18 is reached carriers 18 are stopped.

The present invention is by no means limited to the above described preferred embodiments. The rights sought are defined by the following claims within the scope of which many modifications can be envisaged. For example, the present invention can be applied to the (wireless) lifting columns illustrated in FIG. 1. Alternatively the invention can also be applied to other types of lifting columns and lifting systems.

What is claimed is:

1. A lifting device for lifting a vehicle, the device comprising:
a frame with a moveable carrier configured for carrying the vehicle;
a drive system which acts on the carrier and is configured for raising and/or lowering the carrier relative to the frame; and
a controller and a control measurement system, wherein the controller is configured for controlling the height of the carrier in response to a measurement signal from the control measurement system, wherein the drive system comprises a motor with an integrated motor controller.

2. The lifting device according to claim 1, wherein components of the drive system are connected with watertight connectors.

3. The lifting device according to claim 2, wherein the connectors connect a first component to a second component of the drive system from below.

4. The lifting device according to claim 1, wherein the motor is a permanent-magnet (PM) motor.

5. The lifting device according to claim 1, wherein the drive system comprises a hydraulic system having a hydraulic reservoir, wherein the reservoir extends over a substantial height of the frame.

6. The lifting device according to claim 5, wherein the control measurement system comprises a sensor configured for generating the measurement signal for determining a control action with the controller related to the drive system of the lifting device, with the sensor configured for generating an indirect measurement signal from the hydraulic system.

7. The lifting device according to claim 1, wherein the drive system comprises a piston rod that is operatively connected to the drive system for raising and/or lowering the carrier relative to the frame, and wherein the control measurement system comprises a piston rod displacement measurement system configured for measuring the displacement of the piston rod.

8. The lifting device according to claim 1, wherein the drive system further comprising an energy supply with one or more batteries.

9. The lifting device according to claim 8, wherein the energy supply comprises at least two batteries.

10. The lifting device according to claim 8, wherein the one or more batteries are provided in or at the frame at a position below the drive system.

11. The lifting device according to claim 8, further comprising a charging device.

12. The lifting device according to claim 11, wherein the controller comprises a charging monitor configured for monitoring a regenerative charging process when lowering a load.

13. The lifting device according to claim 12, wherein the controller further comprises a resistance and a switch circuit that are operatively connected to the charging monitor and capable of preventing overcharging of the one or more batteries.

14. The lifting device according to claim 1, wherein the frame comprises a foot having a tapering part with an additional running wheel at or near a front of the foot of the frame.

15. The lifting device according to claim 1, further comprising a modular cartridge comprising an additional running wheel at or near a front of a foot of the frame.

16. The lifting device according to claim 1, wherein the controller comprises a connectivity module configured for communicating with an external system.

17. The lifting device according to claim 1, wherein the lifting device comprises a mobile lifting column.

18. The lifting device according to claim 3, wherein the drive system further comprises an energy supply with one or more batteries, wherein the energy supply comprises at least two batteries, wherein the one or more batteries are provided in or at the frame at a position below the drive system, the lifting device further comprising a charging device, wherein the controller comprises a charging monitor configured for monitoring a regenerative charging process when lowering a load, and wherein the controller further comprises a resistance and a switch circuit that are operatively connected to the charging monitor and capable of preventing overcharging of the one or more batteries.

19. A lifting system comprising at least one group of two or more lifting devices, wherein the lifting devices comprise:
a frame with a moveable carrier configured for carrying the vehicle;
a drive system which acts on the carrier and is configured for raising and/or lowering the carrier relative to the frame; and
a controller and a control measurement system, wherein the controller is configured for controlling the height of the carrier in response to a measurement signal from the control measurement system, wherein the drive system comprises a motor with an integrated motor controller.

20. A method for lifting a vehicle with a lifting device or lifting system, the method comprising the steps of:
providing a lifting device or a lifting system comprising at least one group of two or more lifting devices, wherein the lifting devices comprise:
a frame with a moveable carrier configured for carrying the vehicle;
a drive system which acts on the carrier and configured for raising and/or lowering the carrier relative to the frame; and
a controller and a control measurement system, wherein the controller is configured for controlling the height of the carrier in response to a measurement signal from the control measurement system, wherein the drive system comprises a motor with an integrated motor controller; and
lifting the vehicle with the drive system acting on the carrier.
